(19) United States
(12) Patent Application Publication
(10) Pub. No.: US 2015/0286348 A1
(43) Pub. Date: Oct. 8, 2015

(54) APPARATUS AND METHOD FOR INTELLIGENT QUERYING AND FILTERING

(71) Applicant: GE INTELLIGENT PLATFORMS, INC., Charlottesville,, VA (US)

(72) Inventor: Peter Hardwick, Plymouth, MA (US)

(21) Appl. No.: 14/440,108

(22) PCT Filed: Feb. 25, 2013
(86) PCT No.: PCT/US13/27570

§ 371 Date: May 1, 2015

Related U.S. Application Data
(60) Provisional application No. 61/721,633, filed on Nov. 2, 2012.

(51) Int. Cl. G06F 3/0482; G06F 17/30

(52) U.S. Cl. CPC G06F 3/0482; G06F 17/30699

(57) ABSTRACT

A method of dynamically controlling data that is to be presented to a user, the method including receiving user content, wherein the user content is associated with at least one portion of a mobile interface and the user content is changeable over time, automatically analyzing the user content, and based upon the analyzing, one or more graphical filtering options are formed, and the one or more graphical filtering options are effective to control information that is to be presented to the user on a display of a mobile device, and presenting one or more graphical filtering options to the user on the display of the mobile device.

### BACKGROUND OF THE INVENTION

1. Field of the Invention

The subject matter disclosed herein relates to querying and filtering information contextually within an application.

2. Brief Description of the Related Art

In any significantly large or complex system, a variety of context sensitive information is available for use. Even with this availability, most applications still try to provide context sensitive searches by expecting a user to pick from a list of options and provide a natural language or regular expression type search string. These previous approaches are time-consuming and error prone. Furthermore, it was very rare that these approaches yielded the desired results on the first attempt.

Additionally, search boxes and manual selection require a significant amount of user interaction and data entry. There could be dozens or hundreds of available options in a complex system. For mobile applications with touch input controls, any operations that require extensive data entry simply must be avoided. In short, most previous systems require that users find the data, assets, or other type of information. Unfortunately, users generally do not want to obtain required data, and instead prefer that the data is found for them.

Because of the above-mentioned problems, users in previous systems were often overwhelmed with data. This created user frustration and dissatisfaction with these previous approaches.

### BRIEF DESCRIPTION OF THE INVENTION

Approaches for intelligent querying and filtering are provided. More specifically, the present approaches provide applications with the functionality to understand various system contexts and utilize this functionality with various filtering techniques.

In one approach, the application may include features such as querying and filtering capabilities that are programmed to be introspective of context sensitive information so as to dynamically construct queries and filters that are applicable only to current context of a user or a mobile device.

In other approaches, when utilized with a geolocation enabled system, an application can have context-sensitive information that is related to geo-spatial or geographic location and use this in filtering. For instance, the application can have context sensitive information regarding assets of interest within a given distance from the user and use this to filter data. In yet other approaches, the querying and filtering functionality will come from servers, clients, or a combination of the two.

The intelligent querying and filtering approaches described herein are either passive or active. Passive querying can be thought of as querying that occurs automatically without the intervention of a user, and active queries can be defined as a query in which the user requests the filter to be applied.

In some passive approaches (such as those involving user privileges and geo-spatial information), the system can retrieve information and operate on only those assets which are within a certain geo-spatial proximity of the user. For assets outside a given proximity the system will decide not to consider data related to those assets in any operations.

In some active approaches, options for filtering and sorting can be limited based on context sensitive information. A user can have access to dozens or more different pieces of context sensitive information which could be used to create various filtering options that are presented to the user.

These and other approaches for intelligent querying and filtering can provide for a user to quickly reduce a potentially large data set to be more manageable. Additionally, utilizing these approaches can result in reduced network bandwidth between a client and server. Further, these approaches can assist users in increasing receptiveness to mobile platforms without fearing a loss in productivity or functionality.

In many of these embodiments, user content is received. The user content is associated with at least one portion of a mobile interface and the user content is changeable over time. The user content is automatically analyzed. Based upon the analyzing, one or more graphical filtering options are formed, and the one or more graphical filtering options are effective to control information that is to be presented to the user on a display of a mobile device. The user selects one of the graphical filtering options.

In other aspects, a predetermined filter is activated to obtain a filter result. In some examples, an operation based upon the filter result is prevented from occurring. In other examples, the one or more graphical filtering options are formed based upon the filter result.

In others of these embodiments, context-related user information is received. The context-related user information includes at least one of security related information related to the user or geo-spatial information regarding the user. A predetermined filter is applied to the context-related user information to determine a filter result. Based upon the filter result, one or more operations (that can be selected by the user) are determined. The user cannot directly affect or choose the operations that are determined. The operations are displayed on a display screen to the user.

In some aspects, the geo-spatial information includes at least one of the latitude, longitude, and altitude of the user. In other aspects, the predetermined filter includes one or more security related rules and the filter applies the security-related rules to the security related information to determine the filter result. In yet other aspects, the predetermined filter includes one or more geo-location related rules and the filter applies the geo-location rules to the geo-spatial information to determine the filter result.

In others of these embodiments, an apparatus that is configured to dynamically control data includes an interface and a controller. The interface has an input and an output and is configured to receive user content at the input. The user content (e.g., a web page) is associated with at least one portion of a mobile interface (e.g., a display) and the user content is changeable over time. The mobile interface may be in the form of web pages, display screens (of any format), to mention two examples.

The controller is coupled to the interface and is configured to automatically analyze the user content. Based upon the analysis, the controller is configured to form one or more graphical filtering options at the output. The one or more graphical filtering options are effective once selected to control information that is to be presented to the user. The controller is further configured to present the one or more graphical filtering options to the user on a display of the mobile device.

### BRIEF DESCRIPTION OF THE DRAWINGS

For a more complete understanding of the disclosure, reference should be made to the following detailed description and accompanying drawings wherein:

FIG. 1 comprises a block diagram of a system for providing filtering options according to various embodiments of the present invention;

FIG. 2 comprises a flow chart of an active filter approach according to various embodiments of the present invention;

FIG. 3 comprises a flow chart of an passive filter approach according to various embodiments of the present invention;

FIG. 4 comprises a block diagram of an apparatus for providing filtering options according to various embodiments of the present invention; and

FIG. 5 comprises a block diagram of a display showing filtering options according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

Approaches are provided whereby a user no longer needs to find or locate data. Instead, through the utilization of the context sensitive information available to the system filters are provided that allow data to flow to the user. By allowing the application to understand various system contexts, (both system wide and locally within a sub component), that application can utilize passive filtering (such as filtering related to a geo-spatial context, a security context, or user preference type settings). The approaches described herein can also dynamically parse through understood contexts and provide active filtering, querying, and even simple sorting based on the current context. Lists of options which might otherwise be very large can be intelligently reduced prior to presenting to a user.

The approaches can be provided in many environments. In a mobile communication environment, having a handful of most relevant filter criteria to click in one or two touches is superior to the standard blank search box with wild card search. Even for complex scenarios, intelligent querying and filtering can be applied.

Application features such as querying and filtering capabilities, both at the system logic level and the user visualization level, can be made to intelligently be introspective of context sensitive information in such a way as to dynamically construct queries and filters that are only applicable to the current context and that will only provide meaningful results based on the that context.

Given a geolocation enabled system, an application will likely have context sensitive information of the geo-spatial nature. Additionally, the application will likely have context sensitive information about the assets of interest within a given distance from the user, as well as the user related context information. Assets, for example, may include controllers for pumps, assembly lines, electrical systems, irrigation systems, just to mention a few examples. Other examples of assets are possible.

Utilizing this information, the application has the ability to modify its queries and filters to provide only those which are useful to the user and internally accessing only those which will provide relevant results to the user.

This querying and filtering functionality can be implemented at servers, clients, or a combination of servers and clients. A client would provide for fine-grained sorting and filtering of data sets while a server may provide for security context based filtering such as not allowing a user access to data or functionality the security context does not allow.

As mentioned, the querying and filtering concepts can sometimes be viewed as either passive or active. Passive querying and filtering can be used to indicate those queries and filters which are applied automatically for a user such as security context. This may also apply to contexts such as geo-spatial with location information is innately available without user interaction.

Some passive filter concepts will not allow user modifications, while others will allow user modifications. For instance, a passive filter not allowing user interaction or modification would be those associated with a security context. On the other hand, a passive filter that might allow user modification could be used with a geo-spatial context. Both types of filtering may be used within a single system. When available, a geolocation may be automatically determined. However, an application may choose to allow a user to specify a location to be used in geo relational contexts. This location may be allowed to be different than a user's known location.

In one example of passive filter approaches (e.g., such as for user privileges and geo-spatial information), the system can retrieve information and operate on only those assets which are within a certain geo-spatial proximity of the user. For assets outside a given proximity the system will decide not to consider data related to those assets in any operations. This can include such operations such as providing lists of available information. It can also be operations such as notifications of changes for data. Those assets outside a given proximity may automatically have notifications suppressed. Similarly with another passive type of intelligent querying and filtering based on context (e.g., that of security or user preferences), a user will not be provided with data or notifications, or be able to perform operations on any assets or data that has been passively filtered out. By “asset” and as used herein, it is meant any electronic (or-non-electronic) device or entity that can process information or provide various functions. Assets, for example, may include controllers for pumps, assembly lines, electrical systems, irrigation systems, just to mention a few examples. Other examples of assets are possible.

As also mentioned, an active query or filter is one applied at the request of a user either by prior configuration or preferences or direct request or activation via a user interface. For active filtering approaches, (i.e., that filtering which the user can directly interact with), options for filtering and sorting could be limited based on context sensitive information. A user might have access to dozens or more different pieces of context sensitive information which could be used in a sort of filter aspect within an application. However, at any given time it would not prove useful to attempt to filter on context which would provide no meaningful results. Making use of specific contexts, the application can modify available filters to provide access to only the most usable ones. An active filter and query context might consist of information related to system health or notifications of alarm conditions that require attention. These filters are then selected by a user to filter various types of information.

In one example of the deployment of active filtering options, a user will not be presented with the option to filter or sort result based alarm criteria unless there exists differing alarm information amongst the assets within the current context. In cases where no assets are in an alarm state, no alarm options will be provided. Similarly, in cases where contexts containing multiple discrete settings are available, only those contexts that would provide meaningful results would be presented to the user.

Alarm levels, or switches, types, distances, and so forth, can all be utilized to determine available levels can provide intelligent options to the user. For example, no selections by type “pump” would be presented unless there were pump type assets in the current context. Similarly (for all other operations), only those alarm levels currently in context would be available as options. This intelligence can be applied wherever there is context sensitive information that can be utilized to determine relevant options. This includes model and hierarchy contexts which allow for an understanding of relationships. Other examples are possible.

One advantage of the approaches provided herein is that these approaches allow a user to quickly reduce a potentially large data set of information to something that is more manageable and understandable by a human. An additional advantage is that of reduced network bandwidth between a client and server. This is particularly useful on mobile devices which may be on metered wireless connections. With intelligent queries and filters requests for only the most important data can be made from a client, and similarly servers can be capable of returning only the data appropriate to the current context, thus greatly reducing the overall network bandwidth and both client/server load.

Another advantage of these approaches is the ability to show customers how their large and complex systems can be quickly and easily navigated even on a touch device with no physical keyboard. Mobility is increasingly important to customers and customers do not wish to lose functionality or productivity. This system and associated processes will help them get to the data they need as easily and with as few steps as possible.

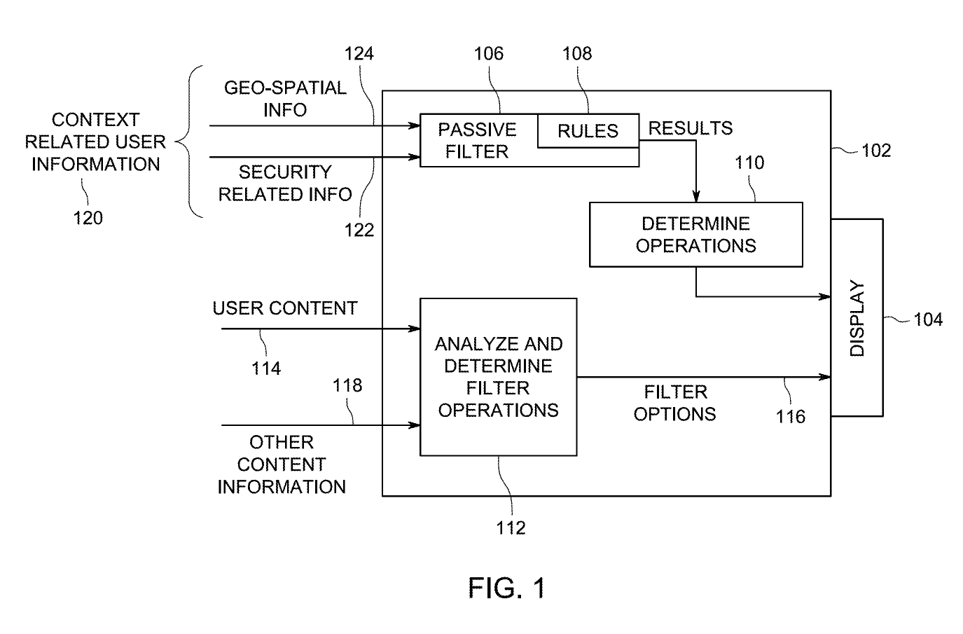

Referring now to FIG. 1, one example of a system that provides intelligent filtering (or queries) is described. It will be appreciated that many of the elements shown in FIG. 1 can be implemented as programmed software operating on a general purpose processing device. However, it will also be understood that any combination of hardware and software may be used to implement these elements. It also will be understood that although most of the description herein relates to filtering that queries are also included within the scope of the disclosed subject matter.

The system includes a processing module 102. The processing module 102 couples to a display 104. In this example, the processing module 102 may be located at a mobile device such as a cellular phone, personal computer, pager, or personal digital assistant. Other examples of deployments are possible. The display 104 may be any type of display that displays images and/or allows user selections of icons/images as known to those skilled in the art. In this respect, the display may include or be coupled to a keyboard, or simply allow a user to make a selection directly at or on the display 104.

The processing module 102 includes a passive filter 106 (including rules 108), a determine operations module 110, and analyze and determine filter operations module 112.

The passive filter 106 and determine operations module 110 implement passive filtering. The passive filter 106 is activated to obtain a filter result. In some examples, an operation based upon the filter result is prevented from occurring. In other examples, the one or more graphical filtering options are formed based upon the filter result.

More specifically, context-related user information 120 is received. The context-related user information may include security related information 122 that is related to the user and/or geo-spatial information 124 regarding the user, assets near the user, or both. The passive filter 106 is applied to the context-related user information to determine a filter result. In this respect, rules 108 may be applied to the received context-related user information 120 to determine a result. Based upon the filter result, one or more operations that can be selected by the user are determined. The user cannot directly affect the operations that are determined. The filtering operations are presented, in on example, on a display 104 to the user.

In one example of passive filtering, the system can retrieve information and operate on only those assets which are within a certain geo-spatial proximity of the user. For assets outside a given proximity (indicated by geo-spatial information 124) the system will decide not to consider data related to those assets in any operations such as providing lists of available information or notifications of changes for data. Those assets outside a given proximity may automatically have notifications suppressed. Similarly with another passive type of intelligent querying and filtering based on context, that of security or user preferences, a user will not be provided with data or notifications, or be able to perform operations on any assets or data that has been passively filtered out.

The analyze and determine filter operations module 112 implements active filtering. In this aspect, user content 114 is received. The user content 114 is associated with at least one portion of a mobile interface (e.g., a web page or the like that is presented on a mobile device) and the user content is changeable over time. The user content 114 is automatically analyzed by the analyze and determine filter operations module 112. Based upon the analyzing, analyze and determine filter operations module 112 forms one or more graphical filtering options 116. The one or more graphical filtering options 116 are effective to control information that is to be presented to the user on the display 104 of the mobile device. A user selects one of the graphical filtering options. Alternatively, other context related information 118 (e.g., geo-spatial information) may be used to determine filter options.

In these approaches, the active filter and query content is input as other context related information 118 and might include information related to system health or notifications of alarm conditions that require attention. Alarm levels, or switches, types, distances, and so forth, can all be utilized to determine available levels can provide intelligent options to the user using the other context related information 118. For example, where pumps near the user were involved, no selections by type “pump” would be presented unless there were pump type assets in the current geographic context (e.g., within a certain distance of the mobile device). Similarly (for all other operations), only those alarm levels currently in context would be available as options. Other examples are possible.

Additionally, there may be situations where a wild card or regular expression type search is necessary. Intelligence derived from context, this system can provide a series of pre-selected regular expressions or wild cards that might yield the desired results.

One example of such an approach includes filtering a list by type where many types are similarly named or there are several sub types such as “Asset ABC”, “Asset XYZ”, and so forth. Given a list such at this, the user can easily be presented with a pre-populated wild card option of “Asset*”. That option may be presented and requires a single click and guarantees no errors from spelling or capitalization. This action only requires several touches on a mobile device as opposed to six or more touches which may result in data entry errors, auto correct errors, and so forth. In other words the user is provided access to what they want, as quickly as possible while using as few steps as possible.

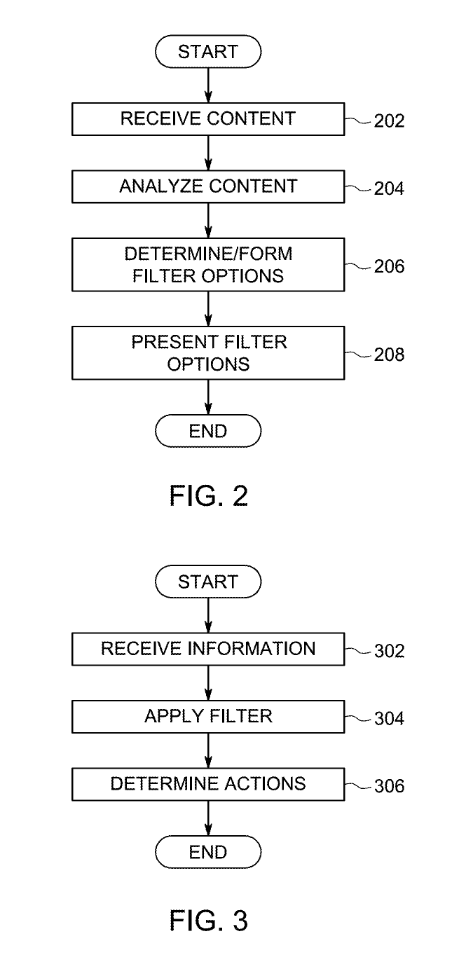

Referring now to FIG. 2, one approach for providing active filter options is described. At step 202, user content is received. The user content is associated with at least one portion of a mobile interface and the user content is changeable over time. At step 204, the user content is automatically analyzed. This function may be accomplished, for example, by programmed software that is configured to analyze and determine the content. At step 206 and based upon the analyzing, one or more graphical filtering options are formed, and the one or more graphical filtering options are effective to control information that is to be presented to the user on a display of a mobile device. At step 208, the one or more graphical filtering options are presented to the user on the display of the mobile device. These options may be presented as icons or as options on a pull-down menu to mention two examples. The user selects one of the graphical filtering options. Once selected, the filtering action represented by the option proceeds.

Referring now to FIG. 3, one approach for passive filtering is described. At step 302, context-related user information is received and includes at least one of security related information related to the user or geo-spatial information regarding the user. At step 304, a predetermined filter is applied to the context-related user information to determine a filter result. And step 306 and based upon the filter result, one or more operations that can be selected by the user are determined. The user cannot directly affect the operations that are determined. The operations are presented, in one example, on a display (e.g., a display screen) to the user.

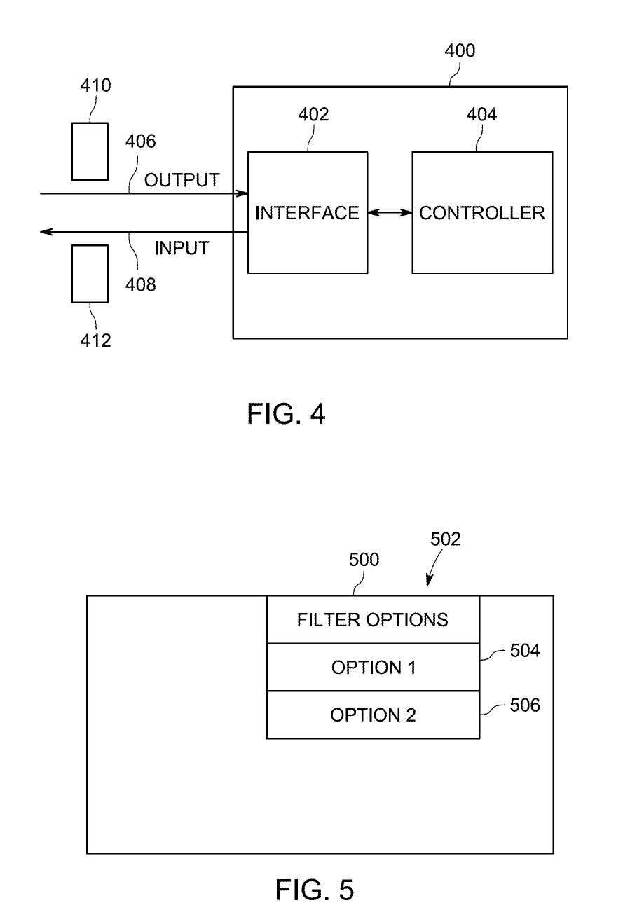

Referring now to FIG. 4, an apparatus 400 that is configured to dynamically control data includes an interface 402 and a controller 404. The interface 402 has an input 406 and an output 408 and is configured to receive user content 410 at the input 406. The user content 410 is associated with at least one portion of a mobile interface and the user content is changeable over time. The apparatus 400 may be implemented on a server or on a client. In another example, it may be distributed among various devices.

The controller 404 is coupled to the interface 402 and is configured to automatically analyze the user content. Based upon the analysis, the controller 404 is configured to form one or more graphical filtering options 412 at the output 408. The one or more graphical filtering options are effective once selected to control information that is to be presented to the user, for example, as icons or in a drop down menu. The controller 404 is further configured to present the one or more graphical filtering options 412 to the user on the display of the mobile device. The user can then select these options and filtering occurs.

Referring now to FIG. 5, one example of active filtering options is described. A display screen 500 includes a pull down menu 502. The pull down menu 502 includes a first filtering option 504 and a second filtering option 506. Alternatively, the first filtering option 504 and/or the second filtering option 506 may be implemented as an icon or icons.

In some examples, an active query or filter is one applied at the request of a user either by prior configuration or preferences or direct request or activation via a user interface. For active filtering approaches, a user might have access to dozens or more different pieces of context sensitive information which could be used in a sort of filter aspect within an application. However, the approaches described herein can modify available filtering options 504 or 506 (displayed on a display) to provide access to only the most usable ones. That is, as the context of the user changes the filtering options presented to the user change.

In one example, an active filter and query context might consist of information related to system health or notifications of alarm conditions that require attention where the controller provides filtering options 504 and 506. In this respect, a user is not presented with the option 504 or 506 to filter or sort result based alarm criteria unless there exists differing alarm information amongst the assets within the current context. In cases where none are in alarm, no alarm options will be provided (i.e., no filtering options 504 or 506 appear). Similarly, in cases where contexts containing multiple discrete settings are available, only those contexts that would provide meaningful results would be presented to the user.

In another example, alarm levels, or switches, types, distances, and so forth, can all be utilized to determine available levels can provide filtering options 504 and 506 to the user. For example, no selections by type “pump” would be presented unless there were pump type assets in the current context. Similarly (for all other operations), only those alarm levels currently in context would be available as filtering options 504 and 506. This intelligence can be applied wherever there is context sensitive information that can be introspected against to determine relevant options.

Embodiments of this invention are described herein, including the best mode known to the inventors for carrying out the invention. It should be understood that the illustrated embodiments are exemplary only, and should not be taken as limiting the scope of the invention.

What is claimed is:

1. A method of dynamically controlling data that is to be presented to a user, the method comprising:
receiving user content, the user content associated with at least one portion of a mobile interface, the user content being changeable over time;
automatically analyzing the user content, and based upon the analyzing forming one or more graphical filtering options, the one or more graphical filtering options being effective to control information that is to be presented to the user on a display of a mobile device; and
presenting the one or more graphical filtering options to the user on the display of the mobile device.

2. The method of claim 1 further comprising a user selecting one of the one or more graphical filtering options.

3. The method of claim 1 further comprising activating a predetermined filter to obtain a filter result.

4. The method of claim 3 further comprising preventing an operation based upon the filter result.

5. The method of claim 1 wherein the one or more graphical filtering options comprise an icon or are presented on a pull down menu.

6. A method of dynamically controlling data that is to be presented to a user on a mobile device, the method comprising:
receiving context-related user information, the context-related user information including at least one of security related information related to the user or geo-spatial information regarding the user;
applying a predetermined filter to the context-related user information to determine a filter result; and
based upon the filter result, determining one or more operations that can be selected by the user, wherein the user cannot directly affect the operations that are determined.

7. The method of claim 6 wherein the operations are displayed on a display to the user.

8. The method of claim 6 where the geo-spatial information includes at least one of a latitude of the user, a longitude of the user, and an altitude of the user.

9. The method of claim 6 wherein the predetermined filter comprises one or more security related rules and wherein the predetermined filter applies the one or more security-related rules to the security related information to determine the filter result.

10. The method of claim 6 wherein the predetermined filter comprises one or more geo-location related rules and wherein the filter applies the one or more geo-location rules to the geo-spatial information to determine the filter result.

11. An apparatus that is configured to dynamically control data that is to be presented to a user, the apparatus comprising:
an interface having an input and an output, the interface configured to receive user content at the input, the user content associated with at least one portion of a mobile interface, the user content being changeable over time; and
a controller coupled to the interface, the controller configured to automatically analyze the user content, and based upon the analysis to form one or more graphical filtering options at the output, the one or more graphical filtering options being effective once selected to control information that is to be presented to the user, the controller further configured to present the one or more graphical filtering options to the user on a display of the mobile device.

12. The apparatus of claim 11 wherein the user selects one of the one or more graphical filtering options on the display.

13. The apparatus of claim 11 wherein the controller is further configured to activate a predetermined filter and to obtain a filter result.

14. The apparatus of claim 13 wherein an operation is prevented from occurring based upon the filter result.

15. The apparatus of claim 13 wherein one or more graphical filtering options are formed at the output based upon the filter result.
